(19) United States
(12) Patent Application Publication
(10) Pub. No.: US 2025/0231354 A1
(43) Pub. Date: Jul. 17, 2025

(54) STAGGERED BREAKOUT ASSEMBLIES USING SPLIT MESH SLEEVING AND THREAD-ON TRANSITION HOUSING

(71) Applicant: CommScope Technologies LLC, Hickory, NC (US)

(72) Inventors: Kenneth Allen SKLUZACEK, Belle Plaine, MN (US); Jonathan R. KAML, Shakopee, MN (US); Scott Martin KEITH, Plano, TX (US)

(73) Assignee: CommScope Technologies LLC, Hickory, NC (US)

(21) Appl. No.: 18/700,641

(22) PCT Filed: Oct. 14, 2022
(86) PCT No.: PCT/US2022/046768

§ 371 Date: Apr. 11, 2024

Related U.S. Application Data
(60) Provisional application No. 63/255,737, filed on Oct. 14, 2021.
(60) Provisional application No. 63/255,746, filed on Oct. 14, 2021.

(51) Int. Cl. G02B 6/38

(52) U.S. Cl. CPC G02B 6/3878

(57) ABSTRACT

The present disclosure relates to staggered breakout assembly using split mesh sleeving. The present disclosure also relates to a staggered breakout assembly having a fiber optic cable that transitions into a plurality fiber optic subgroups at a main transition housing and a plurality of furcations at a plurality of furcation tube transition housings. The present disclosure also relates to a split mesh sleeving including a longitudinal seam having an open and closed position with a bias toward the closed position, wherein the split mesh sleeving has breakout openings circumferentially spaced from the longitudinal seam to enable furcations to travel through the breakout openings.

### CROSS-REFERENCE TO RELATED APPLICATION(S)

This application is being filed on Oct. 14, 2022, as a PCT International application and claims the benefit of and priority to U.S. Application No. 63/255,737, filed on Oct. 14, 2021, titled STAGGERED BREAKOUT ASSEMBLIES USING SPLIT MESH SLEEVING and U.S. Application No. 63/255,746, filed on Oct. 14, 2021, titled CABLE WITH THREAD-ON TRANSITION HOUSING, the disclosures of which are hereby incorporated by reference in their entireties.

### BACKGROUND

Telecommunications systems typically employ a network of telecommunication cables capable of transmitting large volumes of data over relatively long distances. The telecommunications cables can include fiber optic cables, electrical cables, or combinations of electrical and fiber optic cables. Fiber optic cables may be organized in a breakout assembly. The purpose of a breakout assembly is to break out fiber optic cables and connectorize the fiber optic cables to a connector or other components such as a fiber optic patch panel. Breakout assemblies may include a very large quantity of fiber optic cables that must be stored in a limited space. Accordingly, improvements in organization and functionality are desirable.

### SUMMARY

The present disclosure relates to the creation of a staggered breakout assembly using a split mesh sleeve. The staggered breakout assembly can include a plurality of fiber optic cables that transition into a plurality fiber optic subgroups at a main transition housing and a plurality of furcations at a furcation tube transition housing. The split mesh sleeving can include a longitudinal seam having an open and closed position with a bias toward the closed position, wherein the split mesh sleeving has breakout openings circumferentially spaced from a longitudinal seam to enable furcations to travel through the breakout openings.

In one example, a staggered breakout assembly in accordance with the principles of the present disclosure can include a cable having a cable jacket containing a plurality of optical fibers. The cable jacket has a jacket wall with a jacket wall thickness. The cable jacket has a jacket end beyond which portions of the optical fibers extend. A breakout sleeve contains the portions of the optical fibers that extend beyond the cable jacket. The breakout sleeve is more flexible than the cable jacket. A transition housing secures the breakout sleeve to the jacket end. The transition housing is secured to the cable jacket by threading the transition housing onto the jacket end. The transition housing includes internal threads that are embedded within the jacket wall thickness of the jacket wall.

In one example, a staggered breakout assembly in accordance with the principles of the present disclosure includes a main transition housing. A main cable includes a plurality of optical fibers that terminate at the main transition housing. The main cable includes two imbedded strength members. The plurality of optical fibers transition into a plurality of multi-fiber bundles at the main transition housing. Each multi-fiber bundle includes fewer optical fibers than the main cable. Each multi-fiber bundle includes at least two optical fibers. A furcation transition housing encompasses the plurality of multi-fiber bundles. A mesh sleeve encompasses the plurality of multi-fiber bundles and the furcation transition housing. The mesh sleeve extends longitudinally along the plurality of multi-fiber bundles. The mesh sleeve includes a seam extending longitudinally along the plurality of optical fibers. The seam includes an open position and a closed position. The seam is biased toward the closed position. The mesh sleeve includes a plurality of openings extending longitudinally along the plurality of multi-fiber bundles. A plurality of furcation tubes extend through the plurality of openings. The plurality of furcation tubes each have a furcation tube first end and a furcation tube second end. The plurality of plurality of multi-fiber bundles transition into the plurality of furcation tubes at the furcation transition housing at the furcation tube first end. Each furcation tube has fewer optical fibers than the plurality of multi-fiber bundles. Each furcation tube has at least two optical fibers. A plurality of connectors are electrically coupled to the furcation tube second end at the plurality of furcation tubes.

In another example, a fiber optic breakout assembly in accordance with the principles of the present disclosure includes a mesh sleeve having a sleeve length that extends between a first sleeve end and a second sleeve end. The mesh sleeve includes a longitudinal seam that extends along the sleeve length between the first and second sleeve ends. The longitudinal seam includes a closed configuration in which longitudinal edges of the mesh sleeve are overlapped. The longitudinal sleeve is biased toward the closed position. The mesh sleeve defines a plurality of breakout openings spaced apart from one another along the sleeve length. The breakout openings are defined through a mesh fabric of the mesh sleeve at locations circumferentially offset from the longitudinal seam. Aa plurality of optical fibers extend longitudinally through the mesh sleeve. The optical fibers extend into the mesh sleeve through the first sleeve end. At least some of the optical fibers extend out of the mesh sleeve through the breakout openings.

In another example, a method for inserting a plurality of optical fibers through a mesh sleeve in accordance with the principles of the present disclosure includes the mesh sleeve having a sleeve length that extends between a first sleeve end and a second sleeve end. The mesh sleeve has a longitudinal seam that extends along the sleeve length between the first and second sleeve ends. The longitudinal seam has a closed configuration in which longitudinal edges of the mesh sleeve are overlapped. The longitudinal sleeve is biased toward the closed position. The mesh sleeve has a plurality of openings includes moving the longitudinal seam to an open position to facilitate installing the plurality of optical fibers within the mesh sleeve. The method for inserting a plurality of optical fibers through a mesh sleeve includes inserting the plurality of optical fibers into the mesh sleeve; inserting a tapered mesh expansion tool into one of the plurality of openings, the mesh expansion tool having a first tool end and a second tool end, the first tool end comprising a taper such that the circumference of the tapered mesh expansion tool increases from the first tool end to the second tool end, the second tool end comprising the conduit; manipulating the tapered mesh expansion tool within one of the plurality of openings to create an enlarged mesh opening; inserting the plurality of optical fibers through the enlarged mesh opening; and moving the longitudinal seam to the closed position to secure the plurality of optical fibers within the mesh sleeve.

In another example, a staggered breakout assembly includes a main transition housing. A main cable includes a plurality of optical fibers. The main cable is terminated by the main transition housing. The main cable includes two imbedded strength members. The plurality of optical fibers transitioning into the plurality of multi-fiber bundles at the main transition housing. Each multi-fiber bundle includes fewer optical fibers than the main cable. Each multi-fiber bundle includes at least two optical fibers. A furcation tube transition housing encompasses the plurality of multi-fiber bundles. A mesh sleeve encompasses the plurality of multi-fiber bundles and the furcation transition housing. The mesh sleeve extends longitudinally along the plurality of multi-fiber bundles. The mesh sleeve includes a seam extending longitudinally along the plurality of optical fibers. The seam includes an open position and a closed position. The seam is biased toward the closed position. The mesh sleeve includes a plurality of breakout openings extending longitudinally along the plurality of multi-fiber bundles. A plurality of furcation tubes extend through the plurality of openings. The plurality of furcation tubes each have a furcation tube first end and a furcation tube second end. The plurality of plurality of multi-fiber bundles transition into the plurality of furcation tubes at the furcation transition housing at the furcation tube first end. Each furcation tube includes fewer optical fibers than the plurality of multi-fiber bundles. Each furcation tube includes at least two optical fibers. A plurality of connectors electrically couple to the furcation tube second end at the plurality of furcation tubes.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

The following drawings are illustrative of examples of the present disclosure and therefore do not limit the scope of the present disclosure. Examples of the present disclosure will hereinafter be described in conjunction with the appended drawings, wherein like numerals denote like elements.

FIG. 1 is a perspective view of the staggered breakout assembly in accordance with the principles of the present disclosure including a split mesh sleeving in accordance with the principles of the present disclosure;

FIG. 2 is a perspective view of a main transition portion of FIG. 1 including a main cable, main transition housing, and a primary mesh sleeve;

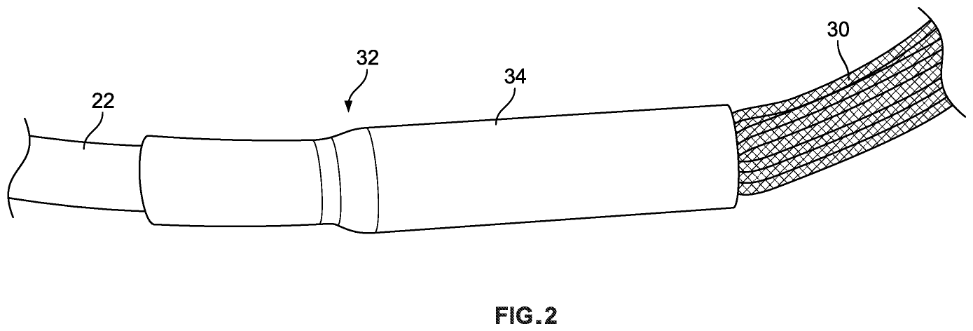

FIG. 3 is a perspective view of the main transition housing of FIG. 2 having a notch;

FIG. 4 is a perspective view of the main transition housing of FIG. 2 having a metallic composition and an injection site for a bonding material;

FIG. 5 is a perspective view of the main transition housing of FIG. 2 having threading on an inside face of the main transition housing;

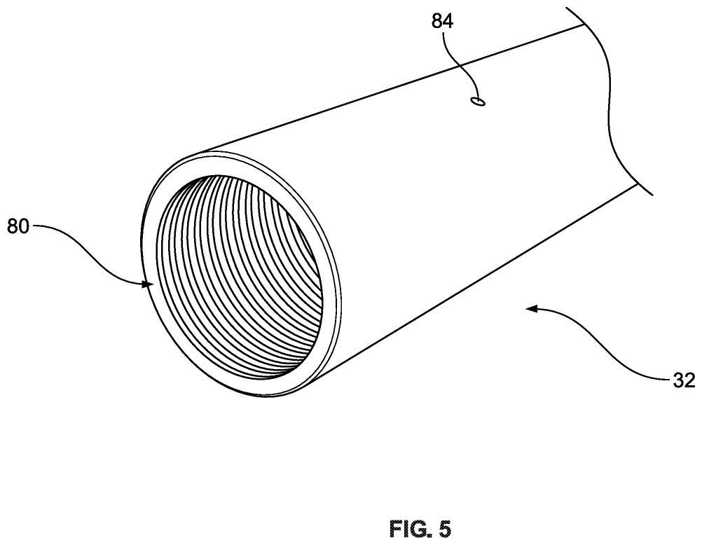

FIG. 6 is an inner, top perspective view of the middle section of the main transition portion of FIG. 1;

FIG. 7 is a cross-sectional view taken along a vertical cross-sectional plane cut through the middle of the main cable;

FIG. 8 is a perspective view of the main transition portion of FIG. 1, including the main transition housing, a cable jacket, and a sealant to seal the main transition housing to the cable jacket;

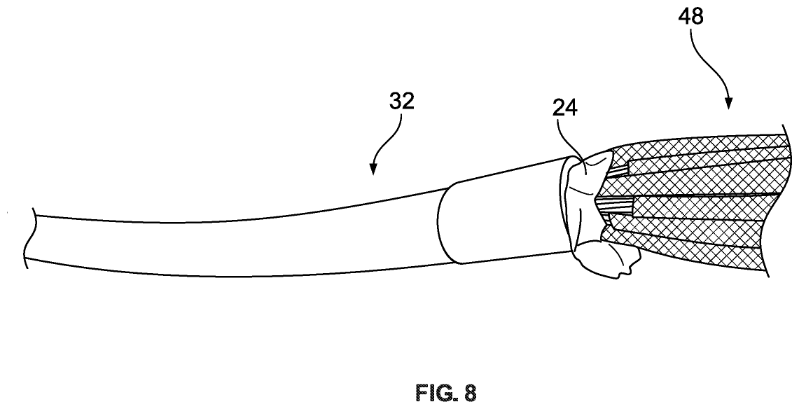

FIG. 9 is a perspective view of the fiber optic subgroups of FIG. 8;

FIG. 10 is a perspective view of the primary mesh sleeve having a longitudinal seam;

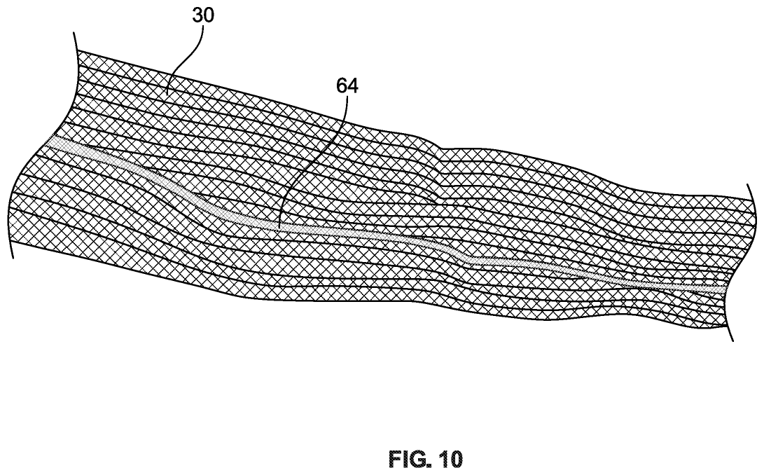

FIG. 11 is a perspective view of the mesh sleeve of FIG. 1 having upjacket tubes protruding from holes within the mesh sleeve;

FIG. 12 is a cross-sectional view taken along a vertical cross-sectional plane cut through the middle of the mesh sleeve.

FIG. 13 is a perspective view and an inner, top view of a mesh-opening tool having a threading needle and a removable coupling;

FIG. 14 is an inner, top perspective view of the middle section of a furcation tube transition housing unit having a fiber subgroup within a primary mesh sleeve transitioning into furcations within a furcation transition housing;

FIG. 15 is a perspective view of the furcation tube transition housing unit of FIG. 13;

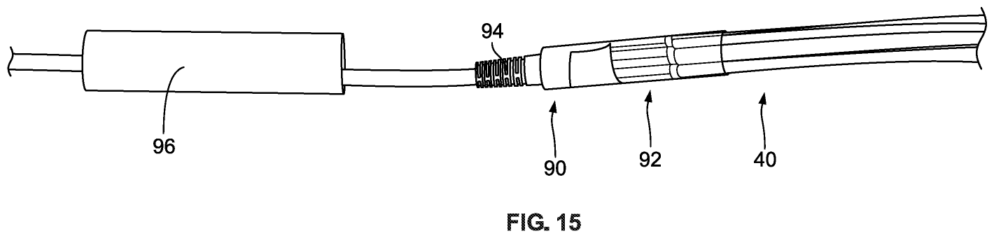

FIG. 16 is an inner, top perspective view of the middle section of another enclosure of a furcation tube transition housing unit in accordance with the principles of the present disclosure having a furcation tube transition housing that is supported by a strain relief boot and furcations that are sealed within the furcation transition housing by a curable bonding material, wherein the furcations terminate at multi-fiber connectors;

FIG. 17 is a perspective view of the furcation transition tube of FIG. 14, wherein the furcations transitioning from the furcation transition tube are staggered with respect to one another;

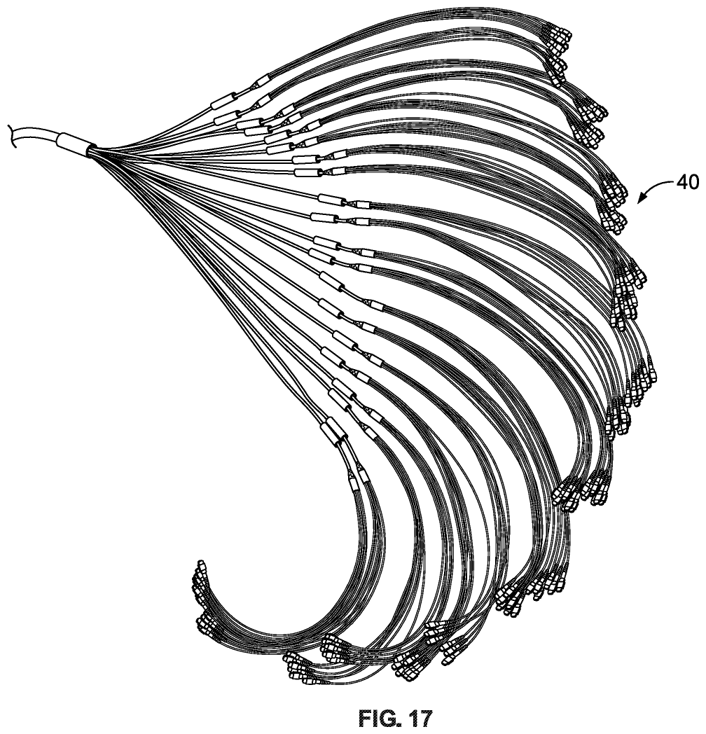

FIG. 18 is a perspective view of the furcation tube transition housing unit of FIG. 16, wherein the staggered furcations are bundled with a staggered furcation wrapping;

FIG. 19 is a perspective view of FIG. 11, further illustrating the staggered furcations protruding from the primary mesh sleeve;

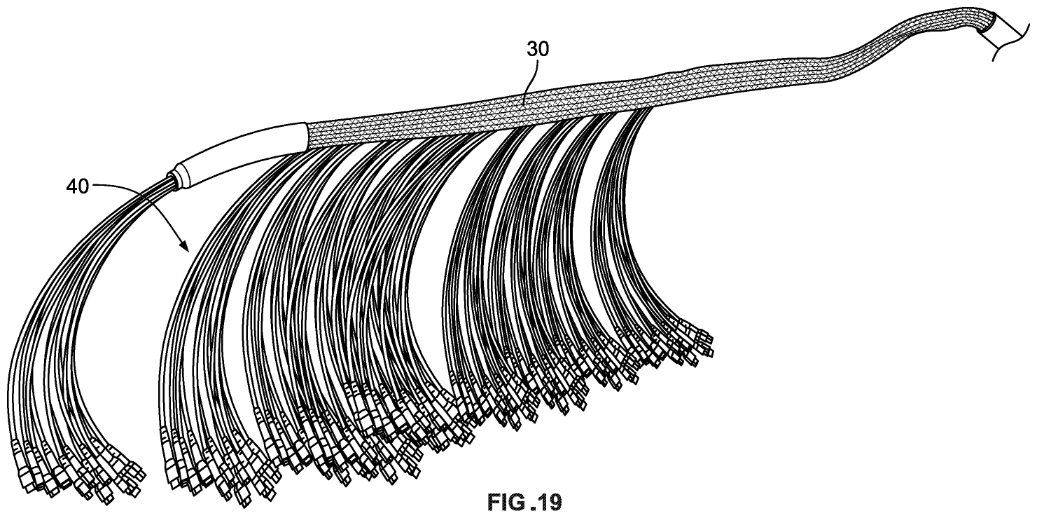

FIG. 20 is a cross-sectional view taken along a vertical cross-sectional plane cut through the middle of the furcation having at least a ribbon of fibers and a reinforcing element within;

FIG. 21 is a perspective view of a breakout unit having several staggered furcations, wherein the breakout unit is wrapped in a packaging material; and

FIG. 22 is a perspective view of the staggered breakout assembly and split mesh sleeving of FIG. 1, wherein the furcations, furcation transition housing, primary mesh sleeve, main transition housing, and a portion of the main cable are wrapped in a packaging material.

### DETAILED DESCRIPTION

Various examples will be described in detail with reference to the drawings, wherein like reference numerals represent like parts and assemblies throughout the several views.

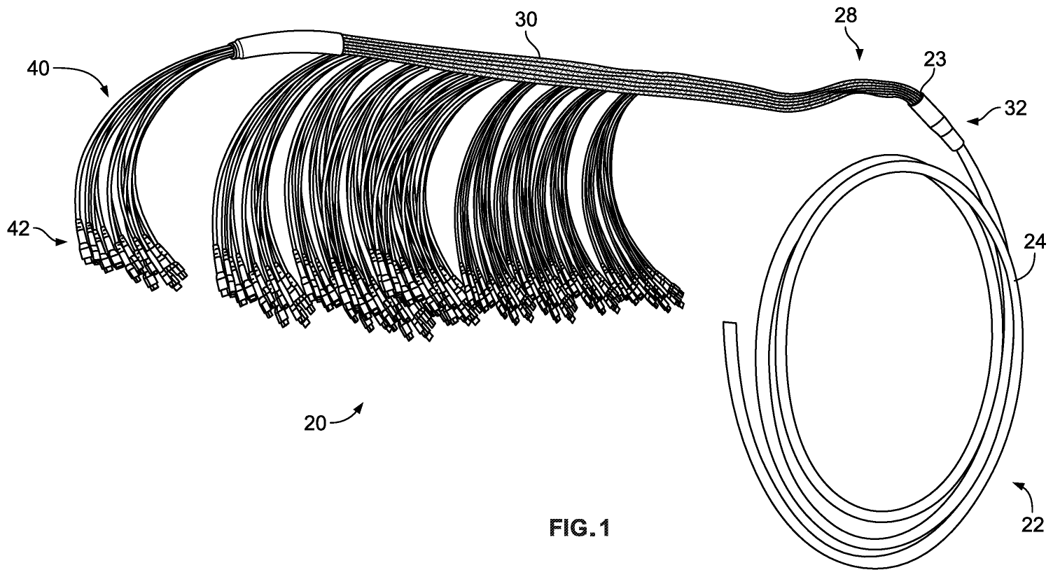

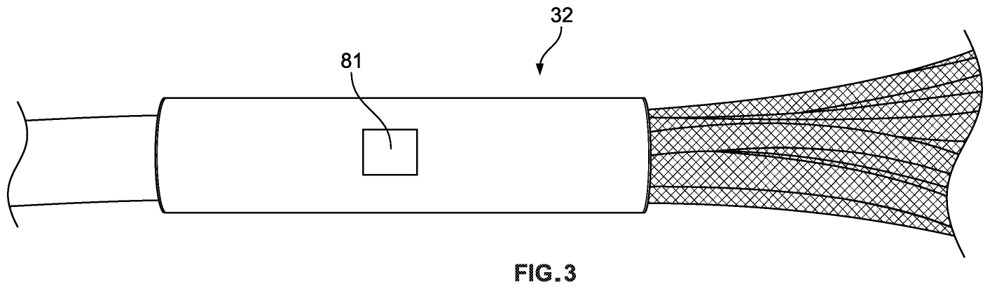

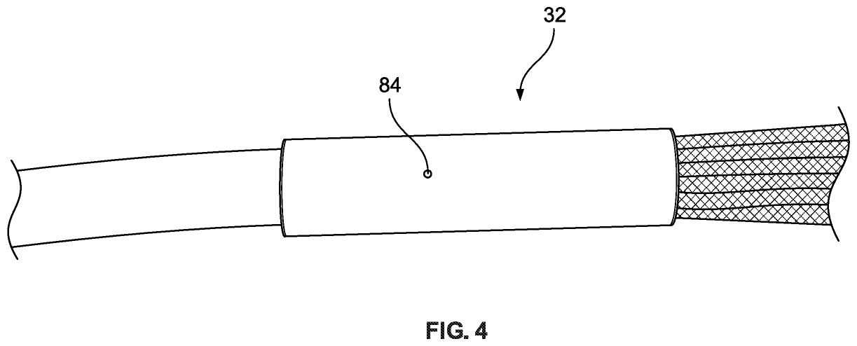

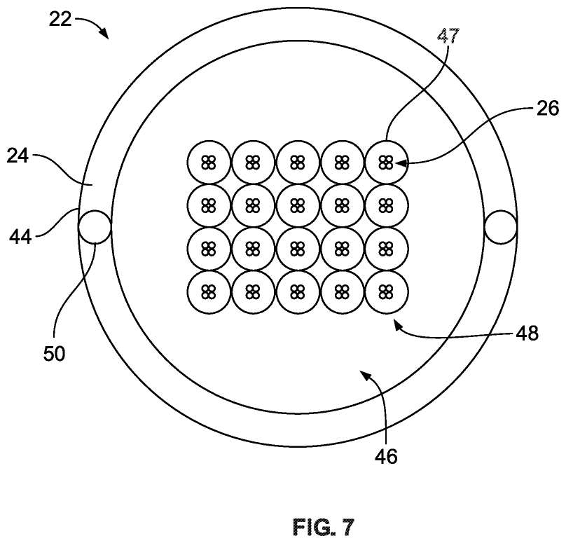

FIG. 1 depicts a cable assembly 20 in accordance with the principles of the present disclosure. The cable assembly 20 includes a main cable 22 having a cable jacket 24 containing a plurality of optical fibers 26 (see FIG. 7). The cable assembly 20 also includes a fiber optic breakout assembly 28 positioned at an end 23 of the cable jacket 24. The fiber optic breakout assembly 28 includes a mesh sleeve 30 (e.g., a main/primary mesh sleeve) secured to the end 23 of the cable jacket 24 by a transition housing 32 (e.g., a main transition housing, see FIGS. 3 and 4). In FIG. 1, the transition housing 32 is covered by an outer sleeve such as a shrinkable sleeve 34 (e.g., a heat-shrink or cold-shrink sleeve). The optical fibers 26 transition from the cable jacket 24 to the mesh sleeve 30 through the transition housing 32. The mesh sleeve 30 preferably has a mesh fabric construction that is more flexible than the cable jacket 24 and is adapted for facilitating breaking out the optical fibers 26 for connection to optical equipment (e.g., to ports of optical panels). The mesh sleeve 30 has a length L and includes a plurality of breakout openings 36 (e.g., side breakout openings) spaced longitudinally along the length L such that the breakout openings 36 are longitudinally staggered relative to one another. In the depicted example, the mesh sleeve 30 also includes an end breakout opening 38. The fiber optic breakout assembly 28 further includes one or more furcation tubes 40 routed out of the mesh sleeve 30 through each of the breakout openings 36, 38. Each of the furcation tubes 40 contains at least one of the optical fibers 26. In a preferred example, each of the furcation tubes 40 contains a plurality of the optical fibers 26 (e.g., 2 optical fibers, 4 optical fibers, 8 optical fibers, 12 optical fibers, 24 optical fibers, etc.). Each of the furcation tubes 40 is terminated by a fiber optic connector 42. In the depicted example, the fiber optic connectors 42 are multi-fiber connectors (e.g., MPO connectors) each having a ferrule capable of supporting a plurality of optical fibers. In alternative examples such as single-fiber examples, the furcation tubes 40 can be terminated by single-fiber connectors such as SC connectors or LC connectors.

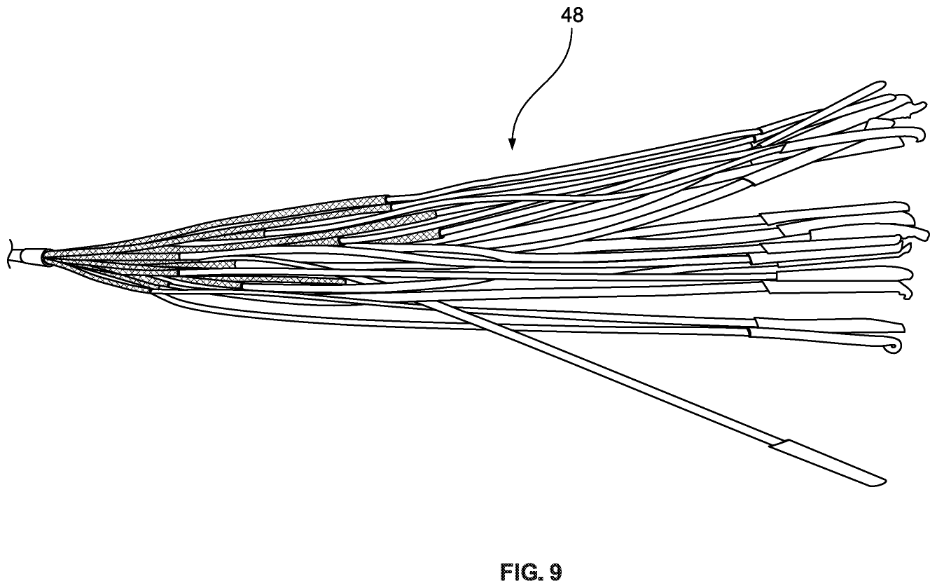

Referring to FIG. 7, the cable jacket 24 of the main cable 22 has a jacket wall 44 with a jacket wall thickness T that extends between an inner diameter and an outer diameter of the cable jacket 24. The cable jacket 24 defines a cable passage 46 in which the optical fibers 26 are contained. In the depicted example, the optical fibers 26 within the cable jacket 24 are separated into a plurality of fiber groups 48 (see FIG. 9) that can be bundled together (e.g., via binder threads 47 helically wrapped around each fiber group 48). The cable jacket 24 can be reinforced by strength members 50 embedded within the jacket wall 44. In one example, the strength members 50 each have a reinforcing rod construction including a glass fiber reinforced polymer such as a glass fiber reinforced epoxy. In other examples, the strength members 50 can have a metal construction or other type of construction. It will be appreciated that the main cable 22 can also include additional reinforcements such as aramid yarn that may be embedded within the jacket wall 44 provided within the cable passage 46. The optical fibers 26 within each of the fiber groups 48 can be subdivided into a plurality of fiber ribbons which may include traditional fiber ribbons or rollable ribbons. In certain examples, the cable jacket 24 has a construction including a polymeric composition that may include polyethylene or ultra-high molecular weight polyethylene.

In certain examples, the main cable 22 can be a high fiber-count cable including a relatively large number of optical fibers. In certain examples, the main cable 22 includes at least 500 optical fibers, or at least 1000 optical fibers, or at least 1500 optical fibers, or at least 2000 optical fibers, or at least 2500 optical fibers. In one example, the main cable 22 includes 2880 optical fibers arranged in 20 fiber groups 48, with each fiber group 48 including 144 optical fibers 26 arranged as 12, twelve-fiber optical ribbons bundled together 126. Of course, fiber optic cables having other fiber counts and other fiber grouping arrangements can also be used in accordance with the principles of the present disclosure.

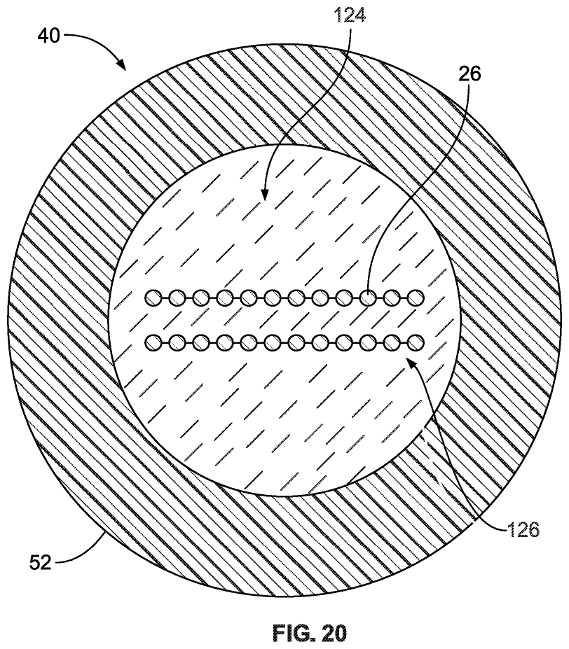

Referring to FIG. 20, each of the furcation tubes 40 includes a furcation tube jacket 52 in which one or more of the optical fibers 26 is contained. In the depicted example, the furcation tube 40 contains 24 of the optical fibers 26 are arranged as two 12-fiber rollable ribbons. As depicted at FIG. 20, the 12-fiber rollable ribbons are shown in a planar configuration but can also be arranged in a non-planar (e.g., a rolled configuration) within the furcation 40 to enhance optical fiber density. Each of the furcation tubes 40 can also contain a plurality of reinforcing members 124 (e.g., aramid yarns). In one example, each of the furcation tubes 40 has an outer diameter in the range of 2-4 mm.

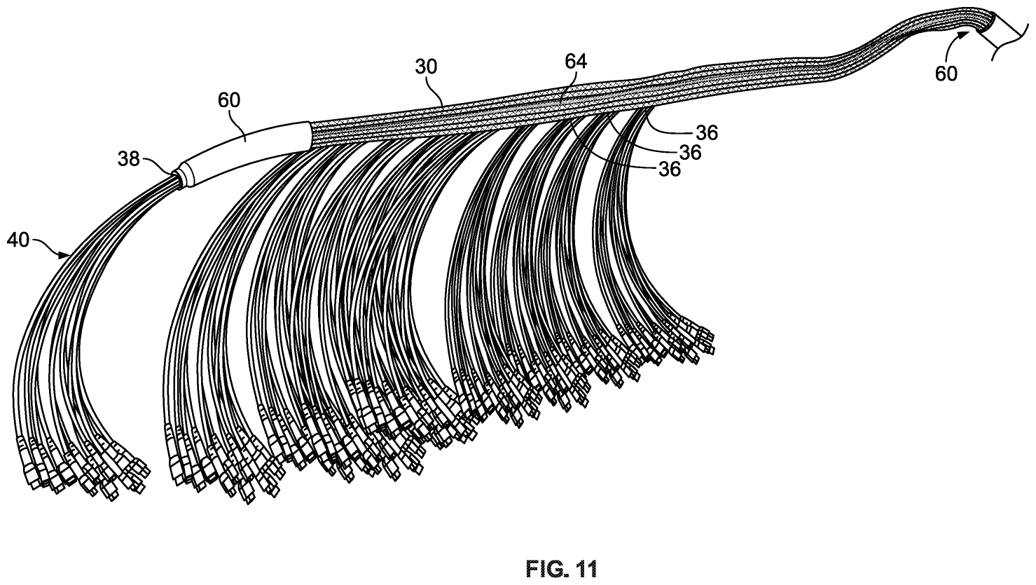

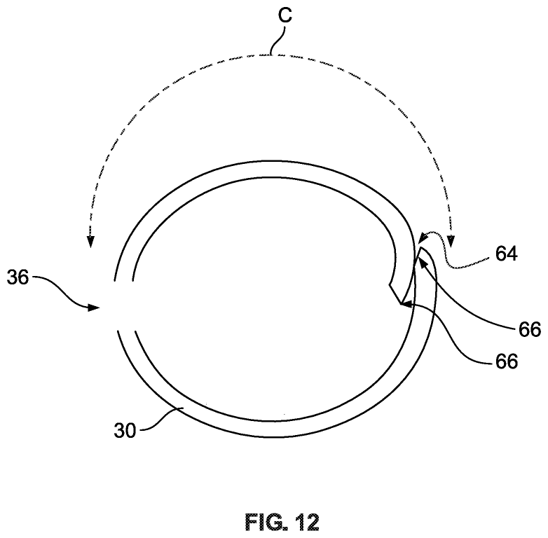

Referring to FIG. 11, the length L of the mesh sleeve 30 extends between a first sleeve end 60 and a second sleeve end 62. The mesh sleeve 30 has a longitudinal seam 64 that extends along the sleeve length L between the first and second sleeve ends 60, 62. As shown at FIG. 12, the longitudinal seam 64 has a closed configuration in which longitudinal edges 66 of the mesh sleeve 30 are overlapped. The mesh sleeve 30 has a resilient construction that inherently biases the mesh sleeve 30 toward the closed configuration. As indicated above, the mesh sleeve 30 defines the plurality of side breakout openings 36 laterally through the fabric material of the mesh sleeve 30. The side breakout openings 36 are spaced apart from one another along the sleeve length L by staggered distances D. Preferably, the side breakout openings 36 are defined through the mesh fabric of the mesh sleeve 30 by expanding localized portions of the mesh fabric without cutting the mesh fabric. As shown in FIG. 12, the side breakout openings 36 are defined through the mesh sleeve 30 at locations circumferentially offset from the longitudinal seam 64. In one example, the side breakout openings 36 are circumferentially offset from the longitudinal seam by a circumferential offset C in the range of 90-270°, or in the range of 135-225°. In the depicted example, the side breakout openings 36 are positioned at a diametrically opposite side of the mesh sleeve 30 from the longitudinal seam 64.

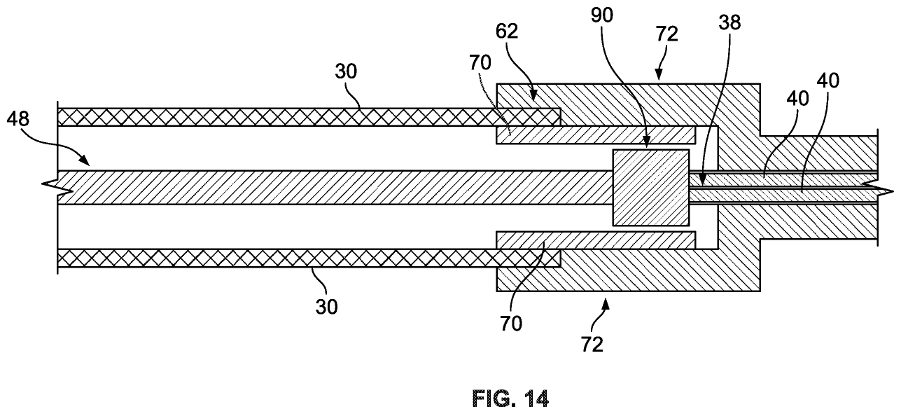

Referring to FIGS. 1 and 14, a plurality of the furcation tubes 40 are also routed out of the mesh sleeve 30 through the end breakout opening 38 defined at the second sleeve end 62. A reinforcing sleeve 70 extends into the mesh sleeve 30 at the second sleeve end 62 to provide reinforcement of the mesh sleeve 30. In one example, the reinforcing sleeve 70 has a corrugated plastic construction. The furcation tubes 40 routed out of the mesh sleeve 30 through the end breakout opening 38 extend through the reinforcing sleeve 70. A shrinkable tube 72 (e.g., a heat shrink or cold shrink tube) is shrunk down upon the second sleeve and 62 and upon portions of the furcation tubes 40 routed out the second sleeve end 62. The shrinkable tube 72 prevents the second sleeve end 62 from unraveling and encloses the second sleeve end 62 around the corresponding for furcation tubes 40. The reinforcing sleeve 70 prevents the second sleeve and 62 from collapsing as the shrinkable tube 72 is shrunk about the mesh sleeve 30.

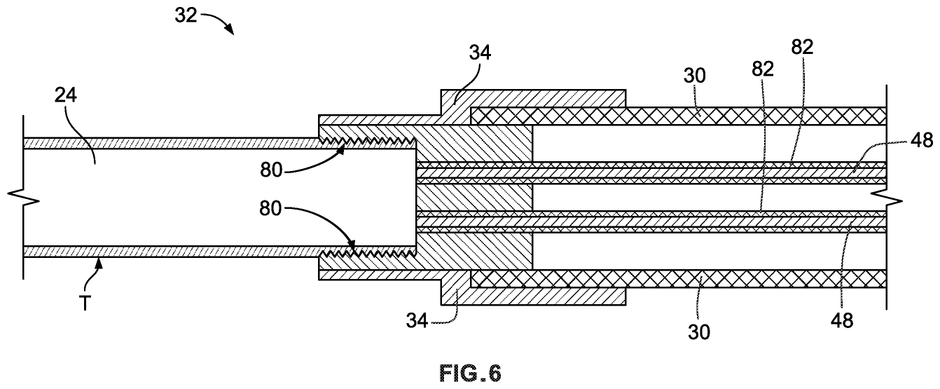

The transition housing 32 is positioned at a location where the cable assembly 20 transitions from the main cable 22 to the mesh sleeve 30. It will be appreciated that the mesh sleeve 30 has a construction that is more flexible than the cable jacket 24 and that can be more readily configured to arrange the optical fibers in a staggered breakout arrangement. The transition housing 32 is configured to secure the mesh sleeve 30 to the end 23 of the cable jacket 24. In the depicted example, the transition housing 32 is secured to the cable jacket 24 by threading the transition housing 32 onto the outer circumference of the cable jacket 24 at the end 23. As shown at FIG. 6, the transition housing 32 two includes internal threads 80 that embed within the jacket wall thickness of the jacket wall 44. In certain examples, the internal threads 80 embedded into the jacket wall thickness a depth that is sufficiently shallow to avoid contact with the strength members 50 of the main cable 22. In other examples, the internal threads 80 embed into the strength members 50 for a depth less than 20% of a cross dimension of the cross-sectional shape of the strength members 50. In certain examples, the internal threads 80 are self-cutting threads that cut into the material of the cable jacket 24 as the transition housing 32 is threaded onto the end of the cable jacket 24. The transition housing 32 can include external features for facilitating applying torque to the transition housing 32 as the transition housing 32 is threaded onto the cable jacket 24. In the depicted example, such structures can include wrench flats 81. It will be appreciated that the transition housing 32 can be made a variety of different materials which may include polymeric materials or metal materials. In one example, the transition housing 32 has a metal construction including a metal material such as aluminum.

It will be appreciated that the optical fibers 26 include portions that extend axially beyond the end 23 of the cable jacket 24, through the transition housing 32 and into the mesh sleeve 30. In certain examples, the optical fibers 26 can be maintained within their separate fiber groups 48 within the mesh sleeve 30 and each of the separate fiber groups 48 can be further protected within the mesh sleeve 30 by separate secondary mesh sleeves 82. The secondary mesh sleeves 82 can be secured within the transition housing 32 by a curable bonding material such as epoxy resin. The transition housing 32 can include features for facilitating injecting the curable bonding material into the interior of the transition housing 32. For example, the transition housing 32 can include one or more injection ports 84 for facilitating injecting curable bonding material into the interior of the transition housing 32 to fill void space within the transition housing 32 to secure the mesh sleeves 82 within the transition housing 32 and to lock the fiber groups 48 in place within the transition housing 32. The mesh sleeve 30 can extend over an exterior of the transition housing 32 and can be secured in place by the shrinkable sleeve 34.

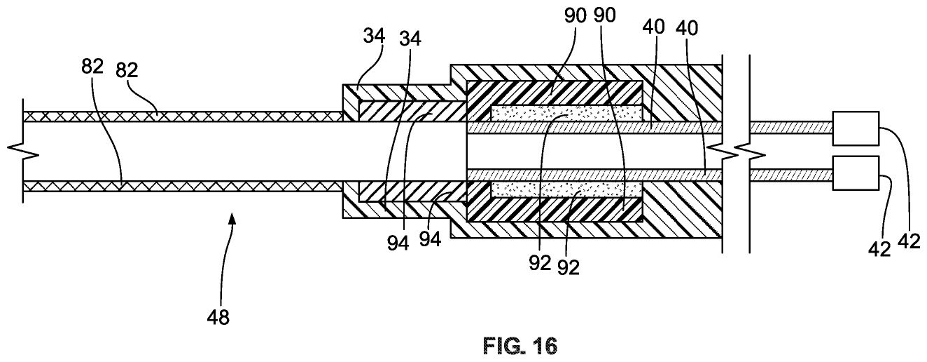

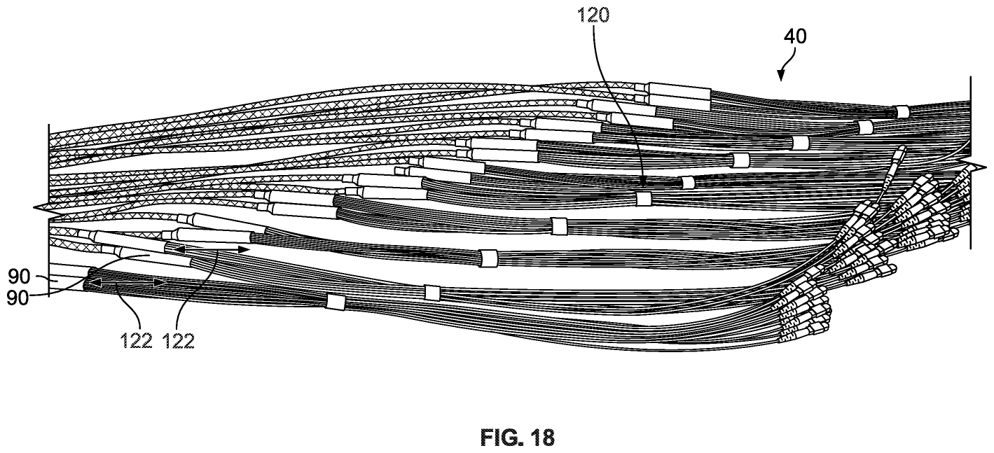

The optical fibers 26 of the fiber groups 48 are transitioned to the furcation tubes 40 within the mesh sleeve 30. For example, furcation tube transition housings 90 can be provided within the mesh sleeve 30 transitioning the optical fibers 26 of the fiber groups 48 to their respective furcation tubes 40. In the depicted example, the furcation tube transition housings 90 can be arranged in an axially staggered configuration with staggered distances generally corresponding to the axially-staggered distances 122 of the breakout openings 36. In the depicted example, one furcation tube transition housing 90 is provided for each of the fiber groups 48 and their corresponding secondary mesh sleeves 82. As shown in FIG. 16, each of the secondary mesh sleeves 82 containing their corresponding fiber groups 48 extends through a strain relief boot 94 mounted at one end of each of the transition housings 90. Within each of the furcation tube transition housings 90, the optical fibers 26 of the corresponding fiber group are routed into their corresponding separate furcation tubes 40. The furcation tubes 40 can be secured within their corresponding furcation tube transition housings 90 by a curable material 92 such as epoxy resin that may be injected into the interiors of the furcation tube transition housings 90 through injection ports defined by the furcation tube transition housings 90. Shrinkable tubes 96 (e.g., heat or cold shrink tubes) can be shrunk over the furcation tube transition housings 90 and portions of the strain relief boots 94 and the furcation tubes 40 to further secure the assemblies together. As shown in FIG. 18, the furcation tube transition housing unit of FIG. 16 may include a furcation tube wrap 120 to bundle the furcation tubes 40.

It will be appreciated that the side breakout openings 36 are preferably made through the mesh material of the mesh sleeve 30 without cutting, tearing or otherwise damaging the fabric of the mesh sleeve 30. This is advantageous because cutting of the mesh sleeve 30 can result in unraveling. Additionally, the resilient construction of the mesh sleeve 30 allows the side breakout openings 36 to close around the furcation tubes 40 after the furcation tubes have been routed through the mesh sleeve 30. By circumferentially offsetting the side breakout openings 36 from the longitudinal seam 64, closing of the seam is uninterrupted and the mesh sleeve 30 can be arranged in a more compact, aesthetically pleasing configuration.

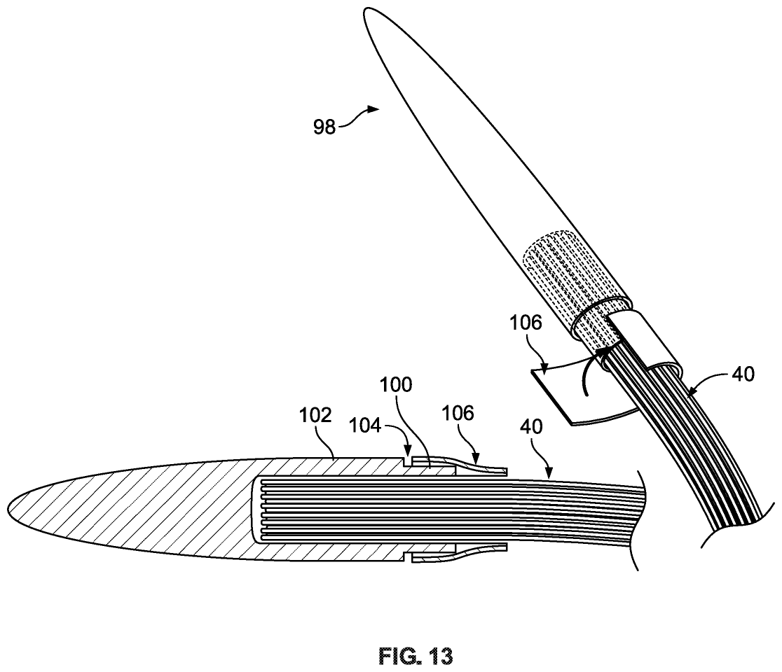

In certain examples, the connectorized furcation tubes can be inserted through the mesh sleeve 30 at the breakout openings 36 using an expansion tool 98. Referring to FIG. 13, the expansion tool 98 can have a tapered configuration adapted to expand a size of the breakout openings 36 as the expansion tool 98 is inserted laterally through the mesh fabric of the mesh sleeve 30. In certain examples, connectorized ends of the furcation tubes 40 can be loaded within the expansion tool 98 and then pulled through the expanded opening defined through the mesh by the expansion tool 98 as the expansion tool 98 is inserted laterally through the mesh material. In certain examples, the connectorized ends of the furcation tubes 40 can be loaded within the expansion tool 98 and secured to the expansion tool with a tool-fiber coupling 106. The tool-fiber coupling 106 may include a removable coupling such as a wrapped adhesive. In certain examples, the expansion tool 98 may include a first tool end and a second tool end, wherein the first tool end includes the tapered configuration adapted for expanding a size of the breakout openings 36 and the second tool end includes a conduit for inserting the connectorized ends of the furcation tubes 40 into the second tool end. The tool-fiber coupling 106 may include a wrapped adhesive that overlaps between the second tool end and the connectorized ends of the furcation tubes 40. In certain examples, the expansion tool 98 may include an expansion tool first segment 100 and an expansion tool second segment 102 that is separated by a step 104. The expansion tool first segment 100 has a smaller diameter than the expansion tool second segment 102, and the step 104 is defined by the change in diameter of the expansion tool 98 as the expansion tool first segment 100 transitions to the expansion tool second segment 102 in a direction traveling from the second tool end to the first tool end. The tool-fiber coupling overlaps the expansion tool first segment 100 and the furcation tubes 40, wherein the step 104 separates the tool-fiber coupling from the expansion tool second segment 102 to prevent the tool-fiber coupling 106 from contacting the mesh sleeve 30 as the expansion tool is inserted laterally through the mesh fabric of the mesh sleeve 30.

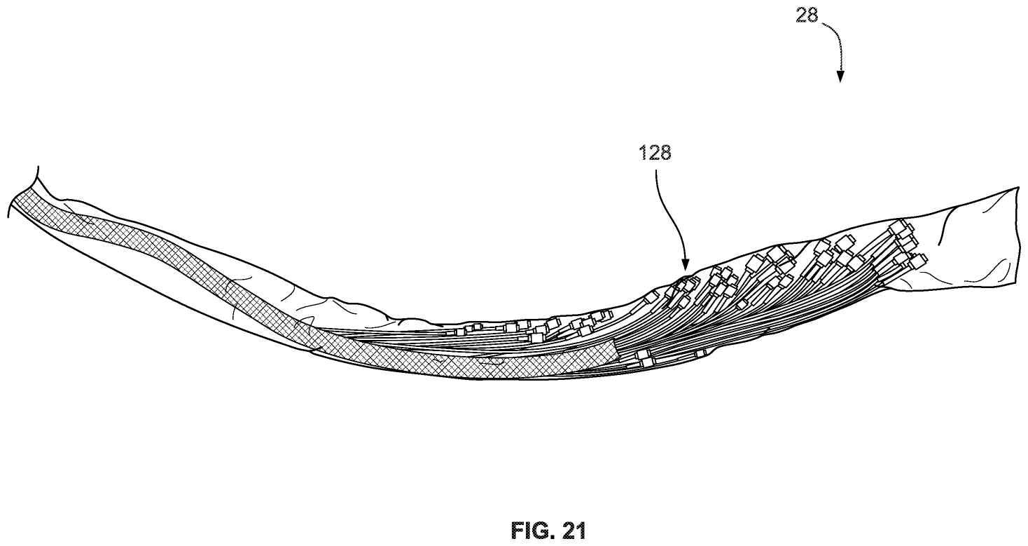

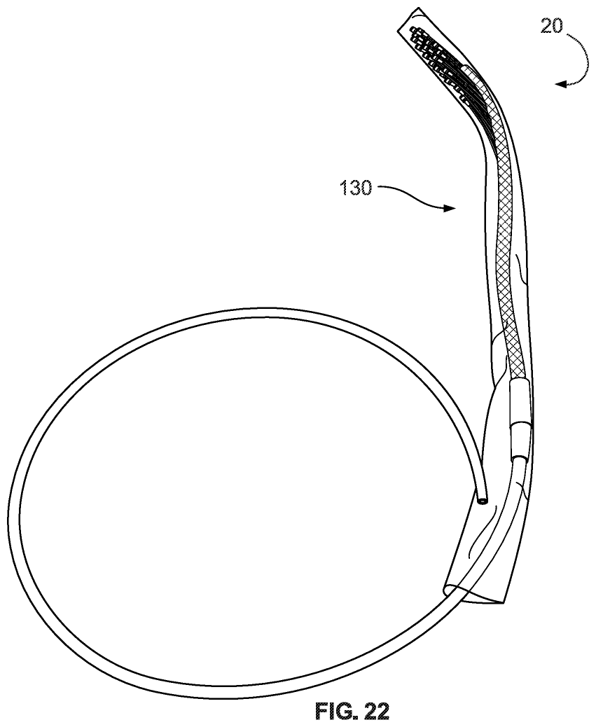

Referring to FIGS. 21-22, in some examples, the cable assembly 20 is packaged into wrapped cable assembly 130 and the fiber optic breakout assembly 28 is packaged into a wrapped breakout assembly 128 for the purpose of organizing and protecting the cable assembly 20 and the fiber optic breakout assemblies 28 when they are not in use.

1-15. (canceled)

16. A fiber optic breakout assembly comprising:
a mesh sleeve having a sleeve length that extends between a first sleeve end and a second sleeve end, the mesh sleeve having a longitudinal seam that extends along the sleeve length between the first and second sleeve ends, the longitudinal seam having a closed configuration in which longitudinal edges of the mesh sleeve are overlapped, the longitudinal sleeve being biased toward the closed position, the mesh sleeve defining a plurality of breakout openings spaced apart from one another along the sleeve length, the breakout openings being defined through a mesh fabric of the mesh sleeve at locations circumferentially offset from the longitudinal seam; and
a plurality of optical fibers that extend longitudinally through the mesh sleeve, the optical fibers extending into the mesh sleeve through the first sleeve end, at least some of the optical fibers extending out of the mesh sleeve through the breakout openings.

17. The fiber optic breakout assembly of claim 16, wherein the breakout openings are defined through the mesh fabric by expanding portions of the mesh fabric without cutting the mesh fabric.

18. The fiber optic breakout assembly of claim 16, wherein during assembly of the fiber optic breakout assembly the longitudinal seam can be moved to an open position to facilitate installing the optical fibers within the mesh sleeve.

19. The fiber optic breakout assembly of claim 16, wherein the breakout openings are circumferentially offset from the longitudinal seam by an amount in the range of 90-270 degrees.

20. The fiber optic breakout assembly of claim 16, wherein the breakout openings are circumferentially offset from the longitudinal seam by an amount in the range of 135-225 degrees.

21. The fiber optic breakout assembly of claim 16, wherein at least some of the optical fibers extend out of the mesh sleeve through the second sleeve end, wherein the second sleeve end is reinforced by a reinforcing sleeve that extends into the second sleeve end and provides the second sleeve end with collapse resistance, and wherein a shrinkable sleeve is shrunk over the second sleeve end and the reinforcing sleeve.

22. The fiber optic breakout assembly of claim 16, wherein the optical fibers are separated into groups of optical fibers within the mesh sleeve, and wherein selected ones of the groups of optical fibers exit the mesh sleeve through corresponding ones of the breakout openings.

23. The fiber optic breakout assembly of claim 22, wherein the mesh sleeve is a primary mesh sleeve, wherein the breakout assembly includes secondary mesh sleeves positioned within the primary mesh sleeve that contain the groups of optical fibers, wherein the breakout assembly includes furcation tube transition housings mounted at ends of the secondary mesh sleeves, wherein at least some of the ends of the secondary mesh sleeves and their corresponding furcation tube transition housings are longitudinally staggered with respect to one another within the primary mesh sleeve, wherein the breakout assembly includes furcation tubes secured within the furcation tube transition housings, wherein the furcation tubes extend from the furcation tube transition housings out of the primary mesh sleeve through corresponding ones of the breakout openings, and wherein optical fibers of the groups of optical fibers are routed into separate ones of the furcation tubes at the furcation tube transition housings.

24. The fiber optic breakout assembly of claim 23, wherein subgroups of the groups of optical fibers are routed into the furcation tubes at the furcation tube transition housings.

25. The fiber optic breakout assembly of claim 24, wherein the optical fibers of the subgroups are arranged in a ribbon or a rollable ribbon configuration.

26. The fiber optic breakout assembly of claim 24, wherein each furcation tube contains at least 12 of the optical fibers and has a free end terminated by a multi-fiber connector.

27. The fiber optic breakout assembly of claim 24, wherein each furcation tube contains at least 24 of the optical fibers and has a free end terminated by a multi-fiber connector.

28. The fiber optic breakout assembly of claim 23, wherein the furcation tube transition housings are filled with a curable bonding material for securing the furcation tubes within the furcation tube transition housings, wherein strain relief boots are provided at locations where the furcation tube transition housings mount to the ends of the secondary mesh sleeves, and wherein shrinkable sleeves are mounted over the furcation tube transition housings.

29. The fiber optic breakout assembly of claim 23, further comprising a main cable having a cable jacket through which the groups of optical fibers extend, the cable jacket having an end to which the first end of the primary mesh sleeve is secured by a main transition housing, wherein the groups of optical fibers extend beyond the end of the cable jacket and into the secondary and primary mesh sleeves.

30. The fiber optic breakout assembly of claim 29, wherein the main transition housing includes internal threads that embed into the cable jacket to secure the main transition housing to the main cable, and wherein the main transition housing is filled with a curable bonding material.

31. A method for inserting a plurality of optical fibers through a mesh sleeve, the mesh sleeve having a sleeve length that extends between a first sleeve end and a second sleeve end, the mesh sleeve having a longitudinal seam that extends along the sleeve length between the first and second sleeve ends, the longitudinal seam having a closed configuration in which longitudinal edges of the mesh sleeve are overlapped, the longitudinal sleeve being biased toward the closed position, the mesh sleeve having a plurality of openings;
comprising:
moving the longitudinal seam to an open position to facilitate installing the plurality of optical fibers within the mesh sleeve;
inserting the plurality of optical fibers into the mesh sleeve;
inserting a tapered mesh expansion tool into one of the plurality of openings, the mesh expansion tool having a first tool end and a second tool end, the first tool end comprising a taper such that a circumference of the tapered mesh expansion tool increases from the first tool end to the second tool end, the second tool end comprising the conduit;
manipulating the tapered mesh expansion tool within one of the plurality of openings to create an enlarged mesh opening;
inserting the plurality of optical fibers through the enlarged mesh opening;
moving the longitudinal seam to the closed position to secure the plurality of optical fibers within the mesh sleeve.

32. The method for inserting a plurality of optical fibers through a mesh of claim 31, wherein the plurality of optical fibers are arranged in optical fiber subgroups, wherein at least one of the optical fiber subgroups are inserted into the second tool end and threaded through an opening using the mesh-opening tool.

33. The method for securing the plurality of optical fibers into the second tool end of claim 31, wherein the plurality of optical fibers secured into the second tool end by wrapping a removable coupling around the second tool end and the plurality of optical fibers.

34. The method of threading the first tool end through the opening of the mesh sleeve using the threading needle of claim 31, wherein the first tool end is threaded at an opening that is circumferentially offset from the longitudinal seam by an amount in the range of 90-270 degrees.

35. The method of threading the first tool end through the opening of the mesh sleeve using the threading needle of claim 31, wherein the first tool end is threaded at an opening that is circumferentially offset from the longitudinal seam by an amount in the range of 135-225 degrees.

36. The method of inserting the plurality of optical fibers through the enlarged mesh opening of claim 31, the method further comprising pushing the first tool end of the tapered mesh expansion tool through one of the openings of the mesh sleeve to expand the opening; pulling the threading needle through the opening; and detaching the plurality of optical fibers from the mesh-opening tool.
